(19) United States
(12) Patent Application Publication
(10) Pub. No.: US 2024/0241915 A1
(43) Pub. Date: Jul. 18, 2024

(54) MACHINE LEARNING MODELS USING CLICKSTREAM-BASED FEATURES FOR ANONYMOUS USERS

(71) Applicant: Intuit Inc., Mountain View, CA (US)

(72) Inventors: Shankar Sankararaman, Burlingame, CA (US); Jingyuan Zhang, San Jose, CA (US); Pragya Tripathi, Oakland, CA (US)

(73) Assignee: Intuit Inc., Mountain View, CA (US)

(21) Appl. No.: 18/096,247

(22) Filed: Jan. 12, 2023

(51) Int. Cl. G06F 16/9535; G06F 11/34

(52) U.S. Cl. CPC G06F 16/9535; G06F 11/3438

(57) ABSTRACT

Systems and methods for inferring recommendations and experiences for anonymous users of an online website are disclosed. Anonymous users of the online website are assigned anonymous user identifiers, and the browsing activity of the anonymous users is converted into features and aggregated over time. The anonymous users' interactions are monitored and used to generate labels that are combined with the feature dataset to produce a training dataset which is used to train a machine learning model. The browsing activity of an anonymous user may be converted into features and aggregated over time and fed into the trained machine learning model from which personalized experiences and recommendations may be generated and provided to the anonymous user.

### BACKGROUND

Online tracking of users is useful for many reasons, such as improving customer engagement and user experience. For example, by tracking visitors to a website, appropriate recommendations and experiences (which may include personalized messaging through text or images or a combination of thereof) for each visitor may be provided. Online tracking of visitors typically relies on identification of the user, e.g., based on a well-defined Customer Data Platform (CDP) that contains information about users. For example, websites that perform matching services, e.g., matching a user with a driver or delivery person, have access to the user data because these models are employed only after users have logged in to the respective websites. Systems that recommend content to users similarly rely on user's information after the user has been authenticated into the system. E-commerce websites also rely on information after users have logged into the system. Prior to logging in or authentication of the system, user information and identification is not available, and consequently, the power of models cannot be fully utilized.

Some systems may use cookies and cookie-based tracking, in which a piece of data is stored within the user's web browser, to identify a user if the user does not log in or authenticate into the system. Increased emphasis on privacy and tracking concerns, however, may block cookies. Consequently, visitors to websites that do not log in or authenticate and that do not have cookies available, may be virtually anonymous with little or no information about the visitor available. Anonymous visitors may access websites but will not benefit from personalized experiences and recommendations from the websites that conventional models may provide.

It is desirable to provide personalized experiences and recommendations to anonymous visitors of online websites.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect described in this disclosure can be implemented as a computer-implemented method for generating recommendations and experiences for anonymous users of an online website. The method includes assigning an anonymous user of the online website with an anonymous user identifier and converting browsing activity by the anonymous user of the online website into features associated with the anonymous user identifier. The method also includes generating a dataset associated with the anonymous user identifier comprising the features aggregated over time and inferring, with a trained machine learning model, personalized experiences and recommendations on the online website for the anonymous user in response to the dataset comprising the features aggregated over time. The method also includes presenting to the anonymous user the personalized experiences and recommendations on the online website.

Another innovative aspect of the described in this disclosure can be implemented as a system for generating recommendations and experiences for anonymous users of an online website. An example system includes one or more processors and a memory storing instructions that, when executed by the one or more processors, cause the system to perform operations. The operations include assigning an anonymous user of the online website with an anonymous user identifier and converting browsing activity by the anonymous user of the online website into features associated with the anonymous user identifier. The operations further include generating a dataset associated with the anonymous user identifier comprising the features aggregated over time and inferring, with a trained machine learning model, personalized experiences and recommendations on the online website for the anonymous user in response to the dataset comprising the features aggregated over time. The operations further include presenting to the anonymous user the personalized experiences and recommendations on the online website.

Another innovative aspect of the described in this disclosure can be implemented as a computer-implemented method for generating recommendations and experiences for anonymous users of an online website. The method includes assigning anonymous users of the online website with anonymous user identifiers and converting browsing activity on the online website for each anonymous user identifier into features associated with each anonymous user identifier. The method further includes monitoring interactions with the online website for each anonymous user identifier to generate labels and generating a training dataset of features associated with corresponding labels generated from the interactions with the online website for each anonymous user. The method further includes training a supervised machine learning model using the training dataset for inference of personalized experiences and recommendations for the anonymous users of the online website in response to browsing activity.

Another innovative aspect of the described in this disclosure can be implemented as a system for generating recommendations and experiences for anonymous users of an online website. An example system includes one or more processors and a memory storing instructions that, when executed by the one or more processors, cause the system to perform operations. The operations include assigning anonymous users of the online website with anonymous user identifiers and converting browsing activity on the online website for each anonymous user identifier into features associated with each anonymous user identifier. The operations further include monitoring interactions with the online website for each anonymous user identifier to generate labels and generating a training dataset of features associated with corresponding labels generated from the interactions with the online website for each anonymous user. The operations further include training a supervised machine learning model using the training dataset for inference of personalized experiences and recommendations for the anonymous users of the online website in response to browsing activity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example computer system that may be used for inferring recommendations and experiences for anonymous users of an online website, according to some implementations.

FIG. 2 shows an illustrative flow chart depicting an example operation of a computer system for training a ML model for inferring recommendations and experiences for anonymous users of an online website, according to some implementations.

FIG. 3A shows a table illustrating a sample feature dataset, according to some implementations.

FIG. 3B shows a table illustrating a sample interaction dataset, according to some implementations.

FIG. 3C shows a table illustrating a sample training dataset, according to some implementations.

FIG. 4 shows an illustrative flow chart depicting an example operation of a computer system for using a trained model to make inferences on recommendations and experiences for anonymous users visiting an online website, according to some implementations.

FIG. 5 shows an illustrative flow chart depicting a computer-implemented method of generating recommendations and experiences for anonymous users of an online website, according to some implementations.

FIG. 6 shows an illustrative flow chart depicting a computer-implemented method of generating recommendations and experiences for anonymous users of an online website, according to some implementations.

Like numbers reference like elements throughout the drawings and specification.

### DETAILED DESCRIPTION

Specific implementations will now be described in detail with reference to the accompanying figures. Like elements in the various figures are denoted by like reference numerals for consistency. In the following detailed description, numerous specific details are set forth in order to provide a more thorough understanding of the present disclosure. However, it will be apparent to one of ordinary skill in the art that aspects of the disclosure may be practiced without these specific details. In other instances, well-known features have not been described in detail to avoid unnecessarily complicating the description.

Before a visitor authenticates into an online website, very little information about the visitor is available to the website server. Visitor-level information, however, is useful as it may be used to effectively improve recommendations and experiences, such as links or information displayed, for a visitor of an online website. For example, machine learning models may be used to infer appropriate recommendations for the best actionable next steps and experiences for a visitor based on visitor-level data. Visitor identification, obtained through logging in or authentication with the website or through the use of cookies, is conventionally used for tracking the visitor and providing appropriate recommendations and experiences for each visitor. Visitors to websites, however, may not log in or authenticate, so that the visitor's identity is unknown. Moreover, reliance on cookies to track a user is becoming more problematic due to ever increasing emphasis on privacy and tracking concerns. Accordingly, visitors to online websites may be effectively anonymous to website servers with little information available for inferring recommendations and experiences to the visitor.

As discussed herein, rather than relying on specific identification through logging in or authentication, or relying on the use of cookies, the browsing activity by an anonymous user of an online website may be used to facilitate effective inference of appropriate recommendations and experiences for the anonymous user. Browsing activity, for example, may include the user's clicks on sections, pages, or links in the online website, as well as the user's views. Tracking of browsing activity by anonymous users may be performed using visitor-IDs, e.g., based on universally unique identifiers (UUIDs), and aggregating browsing activity into features that power ML models. The browsing activity, for example, is monitored to obtain clickstream data, which is converted into features. A real-time clickstream processing pipeline may be used to compute such features continuously as a function of time. These features along with associated user interactions with the website may be to generate a training dataset used to train and deploy machine learning models to infer recommendations and experiences. A trained machine learning model may use the clickstream processing pipeline to produce browsing activity based features for an anonymous user for real-time inference of recommendations and experiences. For example, if anonymous visitors view certain pages to obtain information on certain information or products offered by the online website, that browsing activity may be used to train a model to infer recommendations and experiences related to the same or related information or products. The clickstream information of subsequent anonymous visitors may be converted into features and fed into the model, thereby leading to inference of personalized recommendations and experiences related to the same or related information or products. Personalized recommendations and experiences, for example, may include information displayed, personalized text shown, links provided, products offered, etc. As an example, the browsing activity of anonymous visitors to read help articles related to cryptocurrency of an online website may be used to train machine learning models and used to infer recommendations to cryptocurrency information and services to anonymous visitors with the same or similar browsing activity.

In implementations discussed herein, a machine learning model may be trained for inferring recommendations and experiences for anonymous users of an online website. The anonymous users of the online website, for example, may be assigned with anonymous user identifiers. The browsing activity for each anonymous user identifier is converted into features that are associated with each anonymous user identifier. The features, for example, may be pages viewed, icons or buttons clicked, time spent on a page of the online website or any combination thereof. The interactions with the online website for each anonymous user identifier are additionally monitored to generate labels. The interactions, for example, may include clicking on recommended experiences, signing in or logging into the online website, purchasing a product or service through the online website, or any combination of the above. A training dataset of features associated with corresponding labels may be generated accordingly for each anonymous user. The training dataset, for example, may be generated by associating corresponding labels to features for each anonymous user identifier based on timestamps of the features and the labels. A supervised machine learning model may then be trained using the training dataset for inference of personalized experiences and recommendations for anonymous users of the online website in response to browsing activity.

In implementations discussed herein, recommendations for anonymous users of an online website may be inferred by a trained machine learning model. An anonymous user of the online website, for example, may be assigned with an anonymous user identifier. The browsing activity by the anonymous user of the online website is converted into features associated with the anonymous user identifier. The features, for example, may be pages viewed, icons or buttons clicked, time spent on a page of the online website or any combination thereof. A dataset associated with the anonymous user identifier is generated based on the features aggregated over time. The trained machine learning model may infer personalized experiences and recommendations on the online website for the anonymous user in response to the dataset, and the anonymous user may be presented with the personalized experiences and recommendations on the online website.

Various aspects of the present disclosure provide a unique computing solution to monitoring inventory items in publicly available inventories that did not exist prior to the creation of machine learning models. The use of embeddings, for example, allows optimized matching of a target object, e.g., the item identified by a user, to the same or similar object out of hundreds, thousands, or even millions, of objects, e.g., a same or similar inventory item in the publicly available inventories, to accurately identified items to be monitored in the publicly available inventories. Such an immense number of potential matches (which may be in the thousands or millions) cannot be performed in the human mind, much less using pen and paper. In addition, such machine learning technology as described herein cannot be performed in the human mind, much less using pen and paper. As such, implementations of the subject matter disclosed herein are not an abstract idea such as organizing human activity or a mental process that can be performed in the human mind.

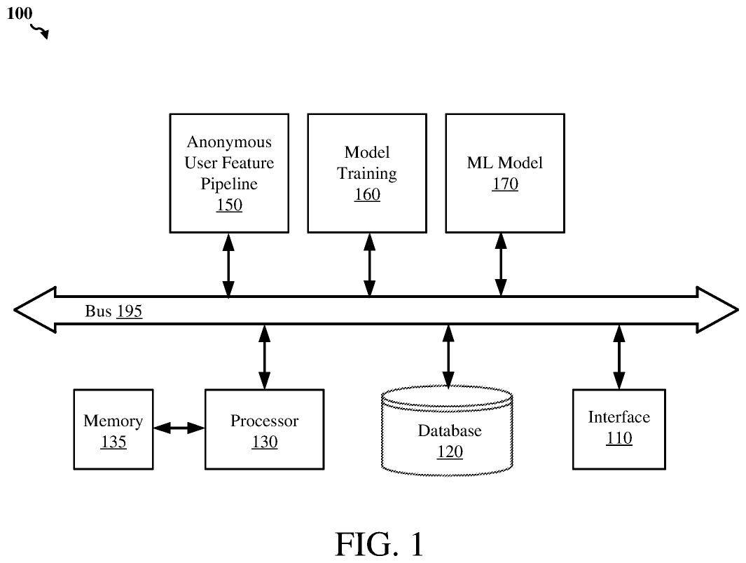

FIG. 1 shows an example computer system 100 that may be used for generating recommendations and experiences for anonymous users of an online website, according to some implementations. The system 100 includes an interface 110, a database 120, a processor 130, a memory 135 coupled to the processor 130, an anonymous user feature pipeline 150, a model training module 160, and a machine learning (ML) model 170. In some implementations, the various components of the system 100 may be interconnected by at least a data bus 195, as depicted in the example of FIG. 1. In other implementations, the various components of the system 100 may be interconnected using other suitable signal routing resources. The system 100 may be or may be part of or connected to a server that provides access to an online website to users via a network, such as the internet.

The system 100 is configured to track anonymous users of an online website based on browsing activity and to train a ML model based on the anonymous user feature pipeline 150 and model training module 160 to infer recommendations and experiences on the online website for the anonymous users. Once the ML model 170 is trained, an anonymous user of the online website may be tracked based on browsing activity, which may be used by the ML model 170 to infer personalized recommendations and experiences on the online website for the anonymous user. The browsing activity, for example, may include the pages viewed, icons clicked, the time spent on a page, etc., and the personalized recommendations and experiences may include information displayed, links provided, products offered, etc. While examples in describing operations of the computer system 100 are sometimes related to personalized recommendations and experiences for marketing for clarity in explaining aspects of the present disclosure, the computer system 100 may be configured to infer personalized recommendations and experiences for any desired reasons, including purely informational reasons.

The interface 110 may be one or more input/output (I/O) interfaces to receive or monitor the user's interaction with an online website, including the users' browsing activity, such as pages viewed, icons clicked, timestamps of the activity, etc., as well as how the users interact with the website, e.g., whether the user clicks on recommended links or other experiences, logs or signs in, purchases products, timestamps for all interactions, etc. The interface 110, for example, may be an interface with the website server or may be an interface with a network through which users access the system 100, e.g., if the system 100 is or is part of the website server. Users need not log in or authenticate to interact with online server and are accordingly considered anonymous users. An example interface may include a wired interface or wireless interface to the internet or other means to communicably couple with other devices. For example, the interface 110 may include an interface with an ethernet cable or a wireless interface to a modem, which is used to communicate with an internet service provider (ISP) directing traffic to and from other devices (such as a user's local computer system and computer systems or servers for accessing the publicly available inventories). In some implementations, the interface 110 may further include a display, a speaker, a mouse, a keyboard, or other suitable input or output elements that allow interfacing with administrators.

The database 120 may store data obtained by the interface 110 and determined by the processor 130, the anonymous user feature pipeline 150, model training module 160, and ML model 170. For example, the database 120 may store anonymous user interactions with the website obtained via the interface 110, such as browsing activity, interactions, and associated timestamps. The database 120 may further store any data generated by the anonymous user feature pipeline 150 including the anonymous user identifiers that are assigned to each user that is associated with the browsing activity, interactions, and associated timestamps, as well as features generated based on the browsing activity and timestamps. The database 120 may further store any data generated by the model training module 160, including a training dataset of features associated with corresponding labels that are generated based on the interactions with the website for each anonymous user. The database 120 may further store parameters for the trained ML model 170, and inferences made by the ML model 170. In some implementations, the database 120 may include a relational database capable of presenting information (such as features and training data sets determined by the computer system 100) as data sets in tabular form and capable of manipulating the data sets using relational operators. The database 120 may use Structured Query Language (SQL) for querying and maintaining the database 120.

The processor 130 may include one or more suitable processors capable of executing scripts or instructions of one or more software programs stored in system 100 (such as within the memory 135). For example, the processor 130 may be capable of executing one or more applications of the anonymous user feature pipeline 150, model training module 160, and ML model 170, as well as providing or implementing the inferences produced by the ML model 170 for the online website. The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. For example, the memory 135 may store the one or more applications of the anonymous user feature pipeline 150, model training module 160, and ML model 170 that may be executed by the processor 130. The memory 135 may also store anonymous user identifiers, browsing activity, interactions, and associated timestamps, as well as training data sets and inferences produced by the anonymous user feature pipeline 150, model training module 160, and ML model 170. In some implementations, hardwired circuitry may be used in place of, or in combination with, software instructions to implement aspects of the disclosure. As such, implementations of the subject matter disclosed herein are not limited to any specific combination of hardware circuitry and/or software.

The system 100 uses the anonymous user feature pipeline 150 to obtain and convert anonymous visitor-level browsing activity into anonymous visitor-level features continuously. The anonymous user feature pipeline 150, for example, may assign an anonymous user identifier to each anonymous user, convert browsing activity associated with each anonymous user identifier into features, e.g., numerical and/or categorical features, that describe, e.g., pages-viewed (including pages that contain help articles, product descriptions, etc.), icons-clicked, time spent, and any other information that indicates the visitor's engagement with the online website. The pipeline may perform real-time clickstream processing to enable real-time computation of the aforementioned features from live data that captures visitors' browsing behavior, which may be stored as a function of time. As a result, each visitor's features, e.g., features associated with each anonymous user identifier, at multiple timestamps in the past are continuously available and stored in a dataset, e.g., in the database 120.

The system 100 uses the model training module 160 to develop a training set for fitting a supervised machine learning model and training the machine learning model. The model training module 160, for example, generates labels for training based on users' past interactions with the website. For example, the labels may be indicative of the result of interactions when experiences are presented to users, e.g., a classification such as whether users click on a provided link or not, or more complex continuous quantities indicative of a success measure, such as time spent on a page or revenue, when visitors interact with the experience. The model training module 160 generates a training dataset based on the features and associated labels, e.g., which may be associated based on anonymous user identifier and timestamps. The training dataset may then be used to train the ML model and the model may be deployed, e.g., using a dockerized container and hosted online using any suitable service.

The system 100 uses the ML model 170 to infer recommendations and experiences for an anonymous user, e.g., based on features associated with the anonymous user identifier assigned to the anonymous user produced by the anonymous user feature pipeline 150. The ML model 170, for example, may be a classifier model, such as xgBoost classifier. The trained ML model 170 receives the features associated with the anonymous user and may make real-time predictions used for recommendations and experiences to be provided to the anonymous user by the website.

While the anonymous user feature pipeline 150, model training module 160, and ML model 170 are depicted as separate components of the system 100 in FIG. 1, the anonymous user feature pipeline 150, model training module 160, and ML model 170 may be included in software including instructions stored in memory 135 or the database 120, may include application specific hardware (e.g., one or more ASICs), or a combination of the above. As such, the particular architecture of the system 100 shown in FIG. 1 is but one example of a variety of different architectures within which aspects of the present disclosure may be implemented. In addition, in other implementations, components of the system 100 may be distributed across multiple devices, may be included in fewer components, and so on. While the examples herein are described with reference to system 100, any suitable system may be used to perform the operations described herein.

If the anonymous user feature pipeline 150, model training module 160, and ML model 170 are implemented in software, the anonymous user feature pipeline 150, model training module 160, and ML model 170 may be implemented using any suitable computer-readable language. For example, the anonymous user feature pipeline 150 and model training module 160 for obtaining features and a training data set and for training the ML model (such as the classification models), may be programmed in the Python programming language using any suitable libraries. For example, the classification ML model 170 may be programmed using the XGBoost Python library.

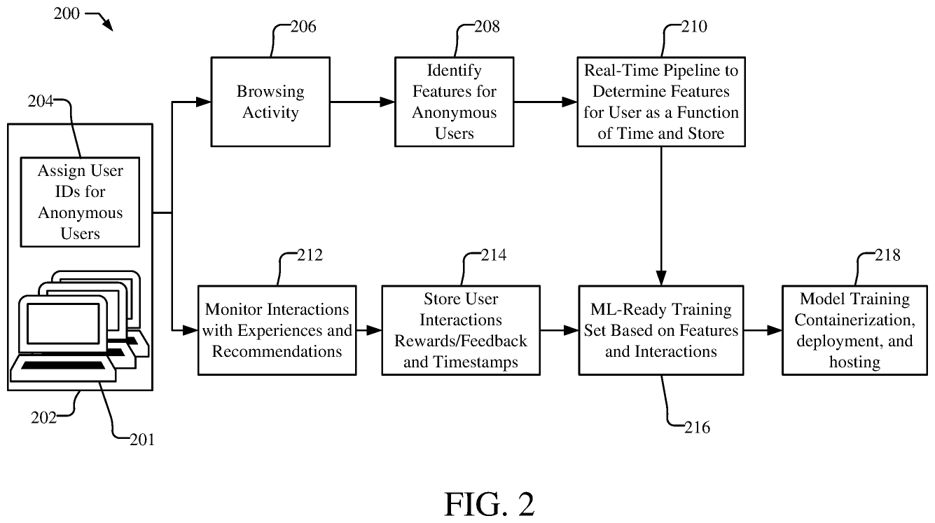

FIG. 2 shows an illustrative flow chart depicting an example operation 200 of a computer system for training a ML model for inferring recommendations and experiences for anonymous users of an online website, according to some implementations. The operation 200 is described as being performed by the computer system 100 shown in FIG. 1 for clarity. The computer system performing operation 200, for example, may include the anonymous user feature pipeline 150 and model training module 160.

As illustrated by block 202, users access an online website via the users' computer systems 201. The users, for example, access the online website without logging in or otherwise performing authentication to interact with the online website, and accordingly, the identities of the users is unknown, i.e., the users are anonymous users. The anonymous users, for example, may access the online website which may be hosted by computer system 100 or may be hosted by a separate server to which computer system 100 is coupled accesses via interface 110. The browsing activity of the anonymous users is converted into visitor-level features that indicate the users' engagement with the online website, e.g., via the anonymous user feature pipeline 150. It should be understood that the anonymous users may access the online website concurrently or over time.

For example, as illustrated, at block 204, anonymous user identifiers (ID) are assigned to each of the anonymous users when each user first visits the website, e.g. by the anonymous user feature pipeline 150. The anonymous user ID, for example, may be a universally unique identifier (UUID). In some implementations, the anonymous user ID may be numeric or alphanumeric string that is assigned to each of the anonymous users, for example, based on the MAC (Media Access Control) address of the computer system 201 used by each anonymous user.

At block 206, the browsing activity of each anonymous user is obtained, e.g., via interface 110. The browsing activity, for example, may include the pages-viewed (including pages that contain help articles, product descriptions, etc.), icons-clicked, time spent, and any other relevant information.

At block 208, features are identified based on the browsing activity for each anonymous user. For example, clickstream data is obtained from the browsing activity for each anonymous user and is converted into numerical and/or categorical features, e.g., by the anonymous user feature pipeline 150.

At block 210, the features associated with each anonymous user, i.e., associated with each anonymous user ID, are determined as a function of time, e.g., by the anonymous user feature pipeline 150, and stored, e.g., in the database 120. A time-dependent feature dataset is generated by continuously storing each user's changing features to enable continuously tracking the changing profile of each anonymous user. As more information about each anonymous user is obtained, the ML model may be trained to make more personalized predictions. The features may be aggregated using multiple aggregation mechanisms, such as summation, most recent value, maximum/minimum possible value, etc. For example, a feature that captures the number of views on a certain page may be aggregated using summation, whereas a feature that captures the oldest or most-recent date of activity may be aggregated using maximum/minimum computation.

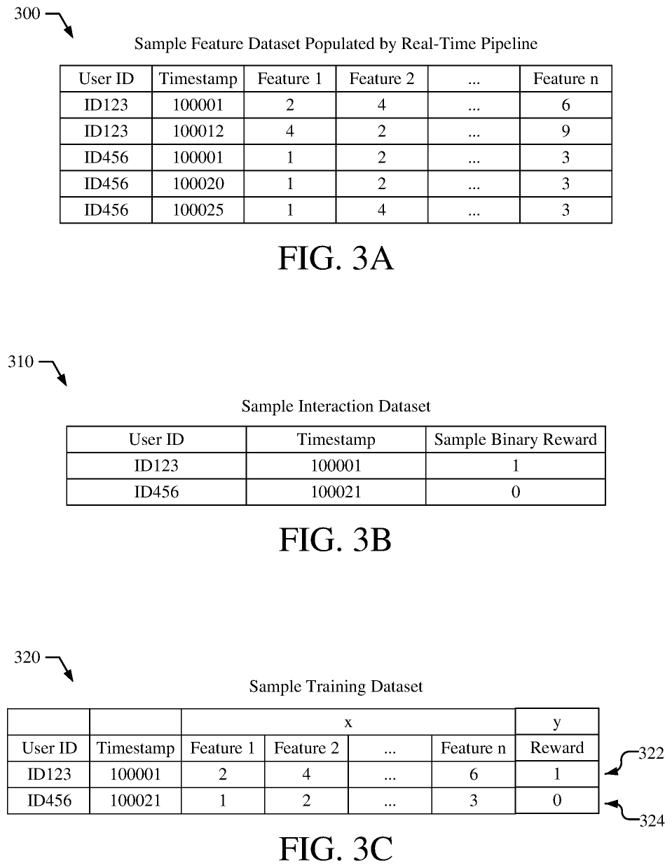

The operations illustrated in blocks 204, 206, 208, and 210 performed by, e.g., the anonymous user feature pipeline 150, provides a real-time clickstream processing pipeline for real-time computation of the aforementioned features from the browsing activity, which is stored as a function of time and anonymous user ID. As a result, a user's features at multiple timestamps in the past are continuously available and stored in a dataset, e.g., in database 120. FIG. 3A, by way of example, illustrates a table 300 with a sample feature dataset that may be generated by the operations of block 210, which includes (i) anonymous user ID, (ii) timestamp at which time the features were computed, and (iii) the values of all the features associated with the anonymous user ID and timestamp.

A ML-ready training dataset that can be fed into a supervised machine learning model is generated based on the anonymous user features dataset from block 210 and the user interactions with the website, e.g., via the model training module 160. The feature dataset from block 210 is not ML-ready for two reasons: it may include multiple rows for each anonymous visitor and does not include labels. To be ML-ready, the feature dataset should have only one row per anonymous visitor. In order to generate labels, the user interactions with experiences and recommendations may be used and as a result, the training dataset may be generated. Further, one row for each visitor is also selected based on the timestamp at which the label was generated.

For example, at block 212, for each anonymous user, the interactions with the experiences and recommendations for the website are monitored, e.g., via the interface 110 and the model training module 160. For training purposes, specific experiences and recommendations are used to generate labels for training based on the user's past interactions with the experiences and recommendations. The labels need to be indicative of the result, e.g., reward or feedback, of a user interaction when the experience or recommendation is presented to a user. For example, in simple scenarios, a label may be a binary indication of whether an experience or recommendation led to specific behavior (e.g., a click, signing in, using a service, purchasing a product, etc.) from a user or not (and thereby posing the machine learning problem as a classification problem). In more complex scenarios, the label may be a continuously varying quantity indicating a success measure (for example, time spent, revenue, etc.) when the user interacted with the experience or recommendation.

At block 214, the user interactions with the website, including rewards and feedback, and associated timestamps, are stored, e.g., in database 120. FIG. 3B, by way of example, illustrates a table 310 with a sample interaction dataset that may be produced by the operations of block 214, which includes (i) anonymous user ID, (ii) timestamp at which time the interaction was recorded, and (iii) the value of the sample reward. In some implementations, as discussed above, some sample rewards may be a continuous varying quantity rather than a binary value.

At block 216, a ML-ready training set is generated based on features (from the feature dataset from block 210) and the stored interactions (from the interaction dataset from block 214), e.g., via the model training module 160. For example, features from the feature dataset and labels from the interaction dataset associated with the same anonymous user ID may be combined based on timestamps. Anonymous users, for example, may visit the website multiple times and may perform various interactions on each visit. By associating timestamps with the interactions, as well as the visitor level features converted from browsing activity, the features that are associated with various interactions may be selected. The timestamps of the interactions may be used to select the timestamps at which features are to be selected for training. Specifically, the timestamp for feature-selection for training may be the timestamp that is immediately prior to or equal to the timestamp of the interaction. Thus, each interaction (or equivalently a label “y”) will have a row of features (“x”) associated with it, and hence, a training set may be generated for machine learning. In this approach, the same anonymous user ID may appear more than once in the training dataset. FIG. 3C, by way of example, illustrates a table 320 with a sample training dataset that may be produced by the operations of block 216, which includes (i) anonymous user ID, (ii) timestamp at which time the interaction was recorded, and (iii) a row of features (label “x”), and (iv) the value of the sample reward (label “y”). In the present example, for example, the sample interaction table 310 shown in FIG. 3B, includes a User ID of ID123 with a binary reward of 1 at timestamp 100001, that is matched with features associated with ID123 at the same timestamp 100001 from the sample feature table 300 shown in FIG. 3A, to produce row 322 in the sample training dataset table 320 shown in FIG. 3C. Additionally, the sample interaction table 310 shown in FIG. 3B, includes a User ID of ID456 with a binary reward of 0 at timestamp 100021, that is matched with features associated with ID456 at the immediately preceding timestamp 100020 from the sample feature table 300 shown in FIG. 3A, to produce row 324 in the sample training dataset table 320 shown in FIG. 3C.

At block 218, the training dataset obtained from block 216 may be fed into a supervised machine learning model, e.g., using the model training module 160. The ML model may be deployed using a dockerized container and hosted online using any suitable service.

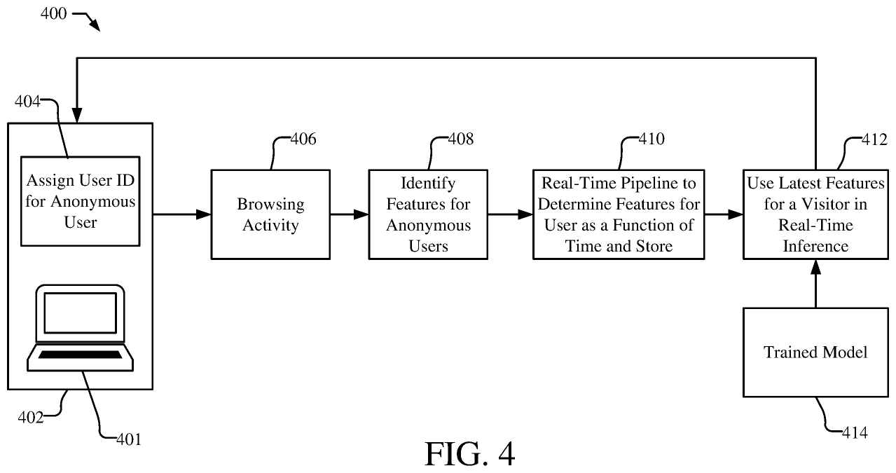

FIG. 4 shows an illustrative flow chart depicting an example operation 400 of a computer system for inferring with a trained ML model recommendations and experiences for anonymous users of an online website, according to some implementations. The operation 400 is described as being performed by the computer system 100 shown in FIG. 1 for clarity. The computer system performing operation 400, for example, may include the anonymous user feature pipeline 150 and ML model 170.

As illustrated by block 402, a user accesses an online website via the user's computer system 401. The user, for example, accesses the online website without logging in or otherwise performing authentication to interact with the online website, and accordingly, the identity of the user is unknown, i.e., the user is an anonymous user. The anonymous user, for example, may access the online website which may be hosted by computer system 100 or may be hosted by a separate server to which computer system 100 is coupled via interface 110. In operation 400, the browsing activity of the anonymous user is converted into visitor-level features that indicate the user's engagement with the online website, e.g., via the anonymous user feature pipeline 150, using blocks 404, 406, 408, and 410.

For example, as illustrated, at block 404, an anonymous user identifier (ID) is assigned to the anonymous user when the user first visits the website, e.g. by the anonymous user feature pipeline 150. The anonymous user ID, for example, may be a universally unique identifier (UUID). In some implementations, the anonymous user ID may be numeric or alphanumeric string that is assigned to the anonymous user, for example, may be based on the MAC (Media Access Control) address of the computer system 401.

At block 406, the browsing activity of the anonymous user is obtained, e.g., via interface 110. The browsing activity, for example, may include the pages-viewed (including pages that contain help articles, product descriptions, etc.), icons-clicked, time spent, and any other relevant information.

At block 408, features are identified based on the browsing activity for the anonymous user. For example, the clickstream data is obtained from the browsing activity for the anonymous user and is converted into numerical and/or categorical features, e.g., by the anonymous user feature pipeline 150.

At block 410, the features associated with the anonymous user, i.e., associated with the anonymous user ID, are determined as a function of time, e.g., by the anonymous user feature pipeline 150, and stored, e.g., in the database 120. A time-dependent feature dataset is generated by continuously storing the user's changing features to enable continuous tracking of the changing profile of the anonymous user. As more information about the anonymous user is obtained, the ML model may make more personalized predictions. The features may be aggregated using multiple aggregation mechanisms, such as summation, most recent value, maximum/minimum possible value, etc. For example, a feature that captures the number of views on a certain page may be aggregated using summation, whereas a feature that captures the oldest or most-recent date of activity may aggregated using maximum/minimum aggregation.

In operation 400, the browsing activity of the anonymous user is converted into visitor-level features as illustrated in blocks 404, 406, 408, and 410, which are similar to blocks 204, 206, 208, and 210 discussed in reference to FIG. 2. The conversion of the browsing activity into visitor-level features provides a real-time clickstream processing pipeline for real-time computation of the aforementioned features from the browsing activity, which is stored as a function of time and anonymous user ID. As a result, the user's features at multiple timestamps in the past are continuously available and stored in a dataset, e.g., in database 120, similar to the dataset for a single user in table 300 shown in FIG. 3A.

At block 412, using a hosted ML model from block 414, e.g., trained in operation 200 shown in FIG. 2 (e.g., trained with a training dataset of features associated with corresponding labels generated from interactions with the online website by a plurality of anonymous users), recommendations and experiences are inferred based on the feature dataset associated with the anonymous user ID determined in block 410, e.g., by the ML model 170 shown in FIG. 1. The latest features, e.g., feature values, obtained from the browsing activity of the anonymous user serve as inputs to the ML model in order for the ML mode to make predictions for recommendations and experiences for the anonymous user, which are provided to the user via the online website at block 402.

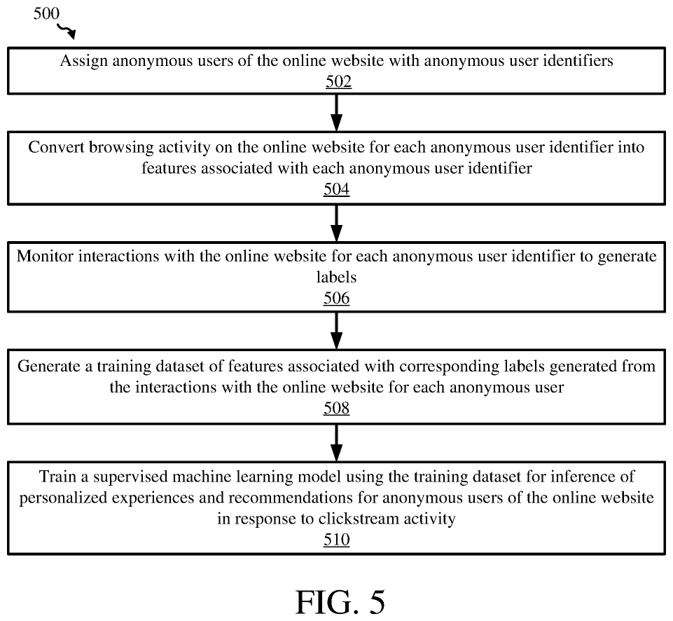

FIG. 5 shows an illustrative flow chart depicting a computer-implemented method 500 of generating recommendations and experiences for anonymous users of an online website, according to some implementations. The method 500, for example, may perform one or more aspects of operation 200 shown in FIG. 2 and may be performed by the computer system 100 shown in FIG. 1.

At block 502, the computer system may track anonymous users of the online website with anonymous user identifiers, e.g., as described in reference to anonymous user feature pipeline 150 in FIG. 1 and block 204 of FIG. 2. The anonymous users of the online website, for example, may be users who have not been identified by the online website, e.g., via a log in or an authentication process.

At block 504, the computer system may convert browsing activity on the online website for each anonymous user identifier into features associated with each anonymous user identifier, e.g., as described in reference to anonymous user feature pipeline 150 in FIG. 1 and blocks 206, 208, and 210 of FIG. 2. For example, the computer system may monitor browsing activity associated with each anonymous user to obtain clickstream data, which is converted into the features associated with each anonymous user identifier. The features, for example, may include at least one of pages viewed, icons clicked, and time spent on a page of the online website.

At block 506, the computer system may monitor interactions with the online website for each anonymous user identifier to generate labels, e.g., as described in reference to model training module 160 in FIG. 1 and blocks 212 and 214 of FIG. 2. For example, the interactions with the online website monitored for each anonymous user identifier to generate labels may include at least one of clicking on recommended experiences, signing in or logging in to the online website, and purchasing a product or service through the online website, e.g., as discussed in reference to model training module 160 in FIG. 1 and block 212 of FIG. 2.

At block 508, the computer system may generate a training dataset of features associated with corresponding labels generated from the interactions with the online website for each anonymous user, e.g., as described in reference to model training module 160 in FIG. 1 and block 216 of FIG. 2.

At block 510, the computer system may train a supervised machine learning model using the training dataset for inference of personalized experiences and recommendations for anonymous users of the online website in response to browsing activity, e.g., as described in reference to model training module 160 in FIG. 1 and block 218 of FIG. 2.

In some implementation, the computer system may generate a dataset including the features aggregated over time associated with each anonymous user identifier and corresponding timestamps, e.g., as described in reference to anonymous user feature pipeline 150 in FIG. 1 and blocks 206, 208, and 210 of FIG. 2, and table 300 of FIG. 3A. The computer system may further generate labels with timestamps based on the interactions with the online website monitored for each anonymous user identifier, e.g., as described in reference to model training module 160 in FIG. 1 and blocks 212 and 214 of FIG. 2, and table 310 of FIG. 3B. The generation of the training dataset of features associated with the corresponding labels may be performed by the computer system by associating the corresponding labels to the features for each anonymous user identifier based on the corresponding timestamps of the features and the timestamps of the labels, e.g., as described in reference to model training module 160 in FIG. 1 and block 216 of FIG. 2, and table 320 of FIG. 3C. For example, in some implementations, the generation of the dataset including the features aggregated over time may include aggregating the features based on at least one summation, most recent value, maximum possible value, and minimum possible value, e.g., as discussed in reference to block 210 of FIG. 2. In some implementations, associating the corresponding labels to the features may include, for each anonymous user identifier, associating a label with a timestamp to a feature with a nearest preceding timestamp, e.g., as described in reference to model training module 160 in FIG. 1 and block 216 of FIG. 2, and table 320 of FIG. 3C.

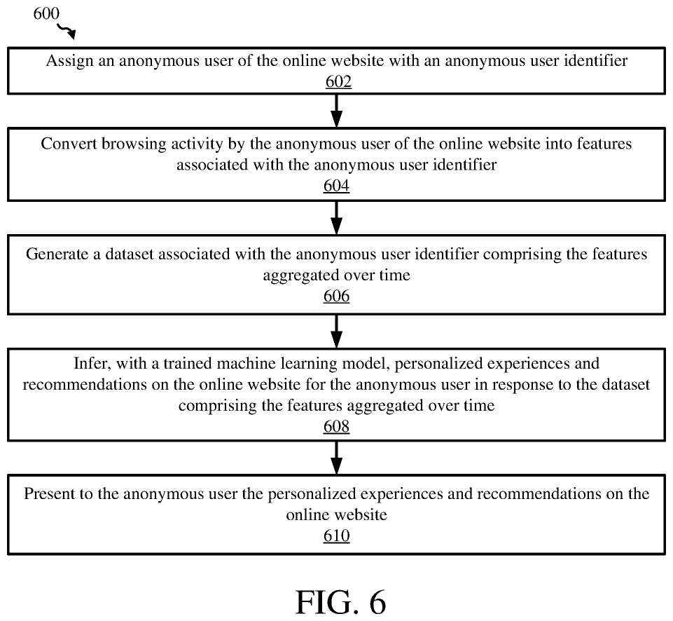

FIG. 6 shows an illustrative flow chart depicting a computer-implemented method 600 of generating recommendations and experiences for anonymous users of an online website, according to some implementations. The method 600, for example, may perform one or more aspects of operation 400 shown in FIG. 4 and may be performed by the computer system 100 shown in FIG. 1.

At block 602, the computer system may assign an anonymous user of the online website with an anonymous user identifier, e.g., as described in reference to anonymous user feature pipeline 150 in FIG. 1 and block 404 of FIG. 4. The anonymous user of the online website, for example, may be a user who has not been identified by the online website, e.g., via a log in or an authentication process.

At block 604, the computer system converts browsing activity by the anonymous user of the online website into features associated with the anonymous user identifier, e.g., as described in reference to anonymous user feature pipeline 150 in FIG. 1 and blocks 406 and 408 of FIG. 4. For example, the computer system may monitor browsing activity associated with each anonymous user to obtain clickstream data, which is converted into the features associated with each anonymous user identifier. The features, for example, may include at least one of pages viewed, icons clicked, and time spent on a page of the online website.

At block 606, the computer system generates a dataset associated with the anonymous user identifier comprising the features aggregated over time, e.g., as described in reference to anonymous user feature pipeline 150 in FIG. 1 and block 410 of FIG. 4. In some implementations, the dataset including the features aggregated over time may be generated by aggregating the features based on at least one of summation, most recent value, maximum possible value, and minimum possible value, e.g., as discussed in reference to block 410 of FIG. 4.

At block 608, the computer system infers, with a trained machine learning model, personalized experiences and recommendations on the online website for the anonymous user in response to the dataset comprising the features aggregated over time, e.g., as described in reference to ML model 170 in FIG. 1 and block 412 of FIG. 4.

At block 610, the computer system presents to the anonymous user the personalized experiences and recommendations on the online website, e.g., as described in reference to ML model 170 and interface 110 in FIG. 1 and blocks 402 and 412 of FIG. 4.

In some implementations, the trained machine learning model is trained with a training dataset of features associated with corresponding labels generated from interactions with the online website by a plurality of anonymous users, e.g., as discussed in reference to model training module 160 in FIG. 1 and block 414 of FIG. 4, and operation 200 of FIG. 2. For example, the interactions with the online website may include at least one of clicking on recommended experiences, signing in or logging in to the online website, and purchasing a product or service through the online website, e.g., as discussed in reference to model training module 160 in FIG. 1 and block 414 of FIG. 4, and block 212 of FIG. 2.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles, and the novel features disclosed herein.

1. A computer-implemented method for generating recommendations and experiences for anonymous users of an online website, comprising:
receiving browsing activity by an anonymous user of the online website via an input/output (I/O) interface of a computer system, wherein the anonymous user of the online website comprises a user who has not been identified by the online website by any of logging in, authentication, or use of a cookie stored on a device of the user;
assigning the anonymous user of the online website with an anonymous user identifier that is stored in a database of the computer system and is not stored as a cookie on the device of the user;
continuously monitoring and converting the browsing activity by the anonymous user of the online website into features associated with the anonymous user identifier;
generating a dataset associated with the anonymous user identifier comprising the features aggregated over time;
inferring, with a trained machine learning model, personalized experiences and recommendations on the online website for the anonymous user in response to the dataset comprising the features aggregated over time; and
presenting to the anonymous user via the I/O interface the personalized experiences and recommendations on the online website.

2. (canceled)

3. The computer-implemented method of claim 1, wherein the features comprise at least one of pages viewed, icons clicked, and time spent on a page of the online website.

4. The computer-implemented method of claim 1, wherein generating the dataset comprising the features aggregated over time comprises aggregating the features based on at least one of summation, most recent value, maximum possible value, and minimum possible value.

5. The computer-implemented method of claim 1, wherein the trained machine learning model is trained with a training dataset of features associated with corresponding labels generated from interactions with the online website by a plurality of anonymous users.

6. The computer-implemented method of claim 5, wherein the interactions with the online website comprises at least one of clicking on recommended experiences, signing in or logging in to the online website, and purchasing a product or service through the online website.

7. A system for generating recommendations and experiences for anonymous users of an online website, the system comprising:
an input/output (I/O) interface;
a database;
one or more processors coupled to the I/O interface and the database; and
a memory storing instructions that, when executed by the one or more processors, causes the system to perform operations comprising:
receiving browsing activity by an anonymous user of the online website via the I/O interface, wherein the anonymous user of the online website comprises a user who has not been identified by the online website by any of logging in, authentication, or use of a cookie stored on a device of the user;
assigning the anonymous user of the online website with an anonymous user identifier that is stored in the database and is not stored as a cookie on the device of the user;
continuously monitoring and converting the browsing activity by the anonymous user of the online website into features associated with the anonymous user identifier;
generating a dataset associated with the anonymous user identifier comprising the features aggregated over time;
inferring, with a trained machine learning model, personalized experiences and recommendations on the online website for the anonymous user in response to the dataset comprising the features aggregated over time; and
presenting to the anonymous user via the I/O interface the personalized experiences and recommendations on the online website.

8. (canceled)

9. The system of claim 7, wherein the features comprise at least one of pages viewed, icons clicked, and time spent on a page of the online website.

10. The system of claim 7, wherein the operation of generating the dataset comprising the features aggregated over time comprises aggregating the features based on at least one of summation, most recent value, maximum possible value, and minimum possible value.

11. The system of claim 7, wherein the trained machine learning model is trained with a training dataset of features associated with corresponding labels generated from interactions with the online website by a plurality of anonymous users.

12. The system of claim 11, wherein the interactions with the online website comprises at least one of clicking on recommended experiences, signing in or logging in to the online website, and purchasing a product or service through the online website.

13. A computer-implemented method for generating recommendations and experiences for anonymous users of an online website, comprising:
receiving browsing activity by anonymous users of the online website via an input/output (I/O) interface of a computer system, wherein anonymous users of the online website comprise users who have not been identified by the online website by any of logging in, authentication, or use of a cookie stored on devices of the users;
assigning the anonymous users of the online website with anonymous user identifiers that are stored in a database of the computer system and is not stored as a cookie on the devices of the users;
continuously monitoring and converting the browsing activity on the online website for each anonymous user identifier into features associated with each anonymous user identifier;
monitoring interactions with the online website for each anonymous user identifier to generate labels;
generating a training dataset of features associated with corresponding labels generated from the interactions with the online website for each anonymous user; and
training a supervised machine learning model using the training dataset for inference of personalized experiences and recommendations for the anonymous users of the online website in response to browsing activity.

14. (canceled)

15. The computer-implemented method of claim 13, wherein the features comprise at least one of pages viewed, icons clicked, and time spent on a page of the online website.

16. The computer-implemented method of claim 13, further comprising:
generating a dataset comprising the features aggregated over time associated with each anonymous user identifier and corresponding timestamps; and
generating labels with timestamps based on the interactions with the online website monitored for each anonymous user identifier;
wherein generating the training dataset of features associated with the corresponding labels comprises associating the corresponding labels to the features for each anonymous user identifier based on the corresponding timestamps of the features and the timestamps of the labels.

17. The computer-implemented method of claim 16, wherein generating the dataset comprising the features aggregated over time comprises aggregating the features based on at least one summation, most recent value, maximum possible value, and minimum possible value.

18. The computer-implemented method of claim 16, wherein associating the corresponding labels to the features comprises, for each anonymous user identifier, associating a label with a timestamp to a feature with a nearest preceding timestamp.

19. The computer-implemented method of claim 13, wherein the interactions with the online website monitored for each anonymous user identifier to generate the labels comprises at least one of clicking on recommended experiences, signing in or logging in to the online website, and purchasing a product or service through the online website.
